(19) United States
(12) Patent Application Publication
(10) Pub. No.: US 2006/0010703 A1
(43) Pub. Date: Jan. 19, 2006

(54) Stud alignment jig

(76) Inventor: Mike Gauthier, Sudbury (CA)

Correspondence Address: MIKE GAUTHIER, UNIT C, 959 ELISABELLA STREET, SUDBURY, ON, P3A 5K1, CA

(21) Appl. No.: 10/892,094

(22) Filed: Jul. 16, 2004

(51) Int. Cl. G01D 21/00

(52) U.S. Cl. 33/613

(57) ABSTRACT

A device that enables speedier wall-stud assembly and accuracy by providing a multi center jig. Three common stud centers include 16″, 19.2″ and 24″. The jig of the present invention comprises; two stud holding end members, a central extension portion having an inner and an outer tube, telescopically engaged to one another wherein each tube member is fixedly attached to a side portion of a stud holding end member. The stud holding end member also incorporates a plate tab, which ensures plate to stud alignment. A wall start setting is also provided for each of the above-mentioned stud centers. A button latch locks the two halves at the desired setting.

### FIELD OF THE INVENTION

The present invention relates to a device, which enables speedier wall stud assembly and accuracy by providing a multi center jig. Three common stud centers include 16″, 19.2″ and 24″. The jig of the present invention comprises; two stud holding end members, a central extension portion having an inner and an outer tube, telescopically engaged to one another wherein each tube member is fixedly attached to a side portion of a stud holding end member. The stud holding end member also incorporates a plate tab, which ensures plate to stud alignment. A wall start setting is also provided for each of the above-mentioned stud centers. A button latch locks the two halves at the desired setting.

### BACKGROUND OF THE INVENTION

It is common for those framing stud walls, to mark the top and bottom plate using a pencil or equivalent marking tool then nail plates to studs. However, wood framing members are more often then not warped or twisted, making it difficult to install said warped studs in perfect alignment. Furthermore, it is desired for studs to be flush with the plates to ensure straighter wall construction.

The inventor sought to provide builders with an easy to use device that automatically places studs in the correct centers, aligns studs with plates and plumbs twisted studs during nailing.

The applicant is aware of attempts in prior art to provide builder with such devices for auto centering studs during wall construction.

An example of prior art may be had when referring to U.S. Pat. No. 3,201,874 of Christy, issued Aug. 24, 1965 depicting a self-positioning stud spacing gauge wherein said instrument is self-positioning on adjacent structural members during use thereby freeing the user's hands to set or nail a member in positioning the building. Although it may be reasonable to assume this device does indeed position the studs generally in their place, it does however fail in many facets; one, that the use of a spring tensioner still allows the warped member to remain warped, two, that it fails to auto-align the plates to the studs, and three, that it fails to be easily adjustable to common spacings.

Another example may be had in referring to U.S. Pat. No. 4,625,415 of Diamontis, issued Dec. 2, 1986, which teaches of a stud spacer for construction comprising a rigid support to which spacers are fixed at longitudinally-spaced intervals corresponding to the distance between studs t hold the latter at the desired spacing while the studs are being secured. The device however fails in that it still allows warped studs to remain warped to be adjustable to common spacings. Furthermore, the device could not be used when adding a stud to a wall, which is existingly paneled.

Yet another example may be had in referring to U.S. Pat. No. 5,628,119 of Bingham et al., issued May 13, 1997, which depicts an adjustable framing jig for framing. Although the jig can straighten warped studs during use, it does however fail to auto align plates to said studs, and also fails to be easily adjustable to common spacings.

### SUMMARY OF THE INVENTION

It is thus the object of the present invention to provide builders with a device that automatically spaces studs in the correct centers, aligns studs with plates and plumbs twisted studs during nailing.

In one aspect of the invention, entry to the stud holding portion may be ramped outwardly so as to ease stud entry into stud holding portions.

In another aspect of the invention, the device of the present invention may be fabricated from any suitable material.

Accordingly, the system of the present invention provides builders with a device that automatically places studs in the correct centers, aligns studs with plates and plumbs twisted studs during nailing.

The utility of the present invention includes but is not limited to wall studs.

### BRIEF DESCRIPTION OF THE DRAWINGS

These and other advantages of the invention will become apparent upon reading the following brief description and upon referring to the drawings in which:

FIG. 1 is a perspective view from above of the stud alignment jig of the present invention.

FIG. 2 is a front elevation view of the stud alignment jig of the present invention shown in the 15.25″ centering position.

FIG. 3 is a front elevation view of the stud alignment jig of the present invention shown in the 18.45″ centering position.

FIG. 4 is a front elevation view of the stud alignment jig of the present invention shown in the 23.25″ centering position.

FIG. 5 is a top plan view of a typical stating stud and plate arrangement.

FIG. 6 is a top plan view of the stud alignment jig setting the arrangement of the second stud in a typical wall framing arrangement.

FIG. 7 is a top plan view of the stud alignment jig setting the arrangement of the third and subsequent studs in a typical wall framing arrangement.

FIG. 8 is a partial perspective view from above of the stud alignment jig of the present invention illustrating the plate tab feature.

FIG. 9 is a cross-sectional view taken from FIG. 1 of the central portions of the stud alignment jig of the present invention illustrating the arrangement of a button latch.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

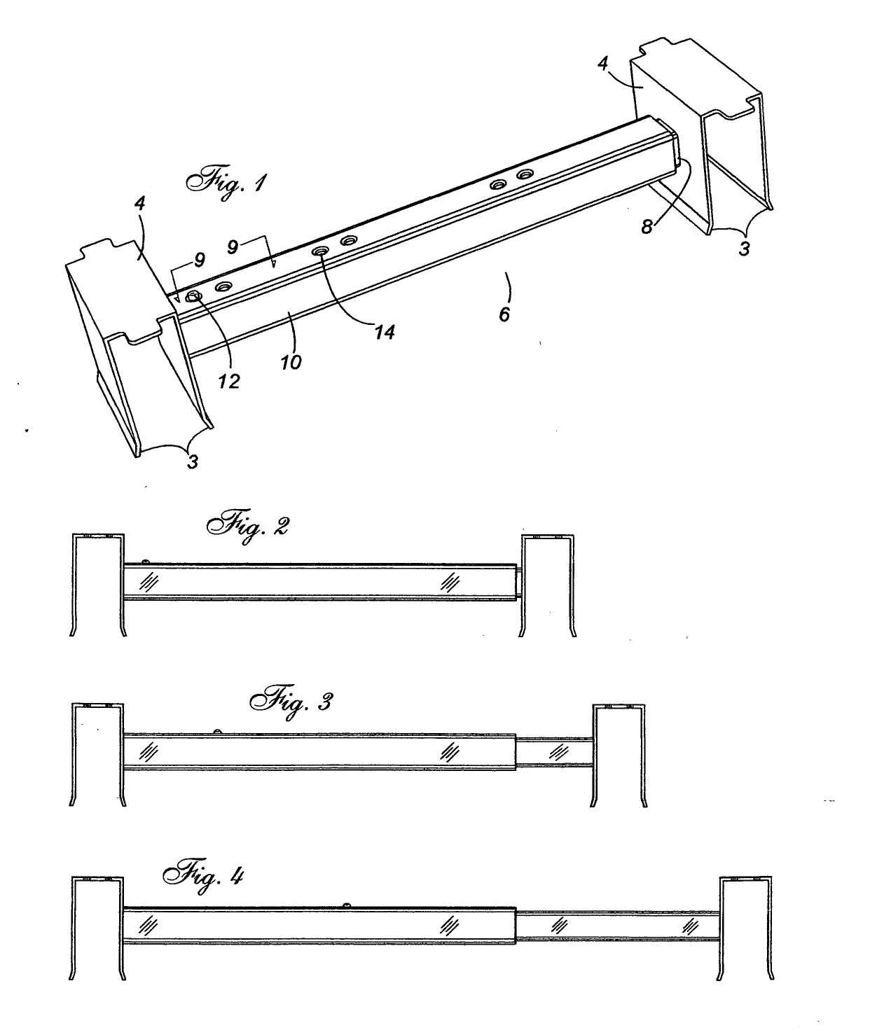

Turning to the drawings, in particular, FIG. 1, a perspective view from above of the stud alignment jig of the present invention comprising two stud holding end members 4, a central extension portion having an inner tube 8 and an outer tube 10 telescopically engaged to one another wherein said tube members 8 and 10 are fixedly attached to a side portion of a stud holding end member 4 respectively, and a button latch 12 inserted within the inner tube's 8 hollow interior, and protruding a single perforation through said inner tube 8. Therefore, the stud holding end members 4, each attached to one of the inner and outer tubes 8 and 10 respectively can slide longitudinally to each other hence varying the distance between each stud holding end member 4. A plurality of desired spacings can be selected and locked in by depressing the button latch 12 downwardly through a series of predetermined mating perforation 14 within the outer tube 10. When the button latch 12 is engaged through any one of the pluralities of outer tube's 10 perforations 14, the longitudinal motion of the mating inner and outer tubes 8 and 10 is then disabled, maintaining this arrangement until the user desire to so change it. Additionally, each stud holding portion 4 is adapted with entry ramps 3 to facilitate the entry of a stud into the stud holding portion.

Turning now to FIGS. 2, 3 and 4, all front elevation views of the stud alignment jig of the present invention shown in various centering positions. Conventional building stud, rafter an joist spacings include predominantly; 16″, 19.2″ and 24″ and to maintain proper sheet spacing from the start of a wall, the starting stud must be inset by half the framing members' thickness. Today, nearly all wall framing materials are 1.5″ thick hence an inset of 0.75″. Therefore a user would thereby use the deducted setting for the desired spacing to start the first two studs.

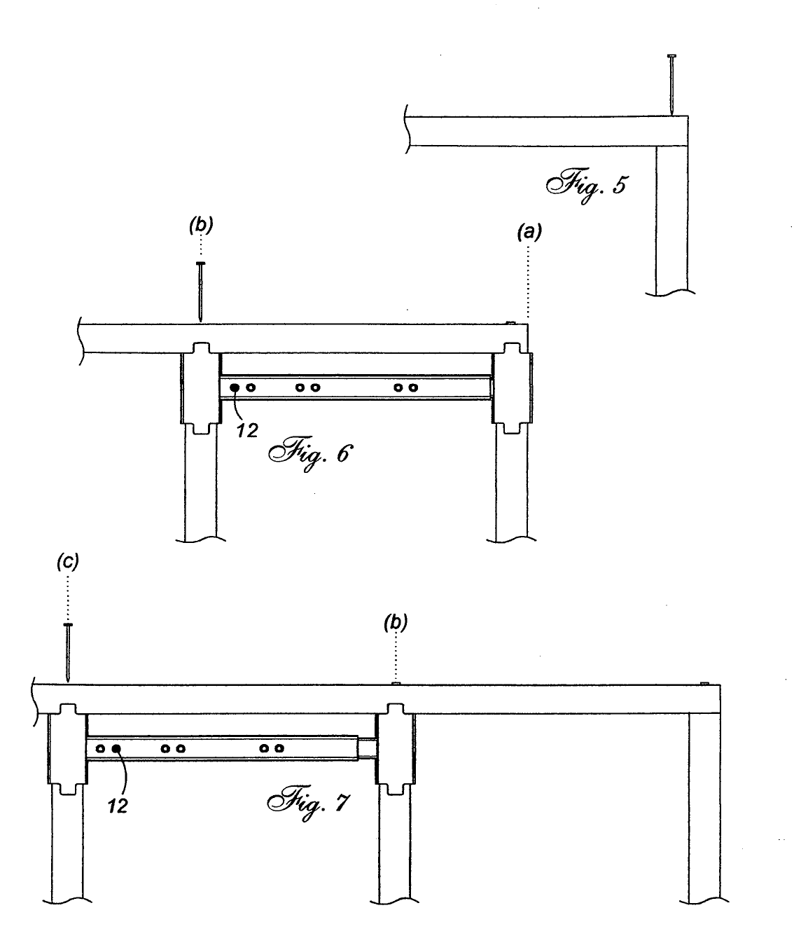

In reference now to FIG. 5, a top plan view of a typical starting stud and plate arrangement wherein, to start virtually any wall, rafter or floor framing section, as illustrated in this wall section, the builder would simply start by securing the plate flush or even to the first stud.

Turning now to FIG. 6, a top plan view of the stud alignment jig setting the arrangement of the second stud in a typical wall framing arrangement wherein the device of the present invention is shown with the button latch 12 set at the 15.25″, which is 0.75″ less than the common 16″ on center spacing thereby aligning the start of the wall (a) and the center of the second stud (b) at 16″.

Turning to FIG. 7, a top plan view of the stud alignment jig setting the arrangement of the third stud in a typical wall framing arrangement wherein the device of the present invention is shown with the button latch 12 set at the 16″ on center spacing thereby aligning the center of the second stud (b) and the center of the third stud (c) at 16″. This arrangement will therefore repeat for the full length of the wall.

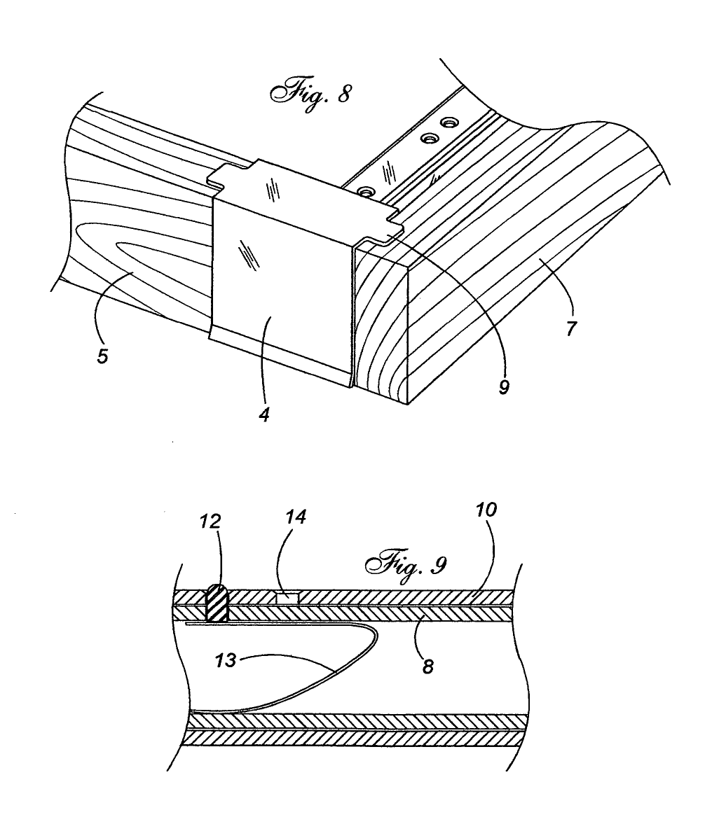

In FIG. 8, a partial perspective view from above of the stud alignment jig of the present invention illustrating the plate tab feature consisting of a portion of the upper portion of the stud holding portion 4 extending outwardly to form a tab 9. When the device is placed over a stud 5 and against the wall plate 7 the tab 9 presses down against the top edge of the plate 7 thereby ensuring a perfect plate-to-stud alignment.

FIG. 9, cross-sectional view taken from FIG. 1 of the central portions 8 and 10 of the stud alignment jig of the present invention illustrates the arrangement of a button latch 12 within the inner hollow of the inner tube 8 wherein the nipple portion of the button latch 12 traverses a single perforation through the upper wall of said inner tube 8, and since the outer tube 10 is longitudinally adjustable in relation to the inner tube 8, one of a plurality of perforations through the outer tube 10 can be selected and locked in where desired.

Therefore, the present invention provides builders with a device that automatically spaces studs in the correct centers, aligns studs with plates and plumbs twisted studs during nailing.

1. A stud alignment jig for framing structures comprising:
a. two stud holding portions,
b. an inner tube fixed attached to a planar surface of a stud holding portion,
c. an outer tube also fixedly attached to a planar surface of an opposite stud holding portion,
d. a button latch,
e. plate tabs, and
f. stud entry ramps.

2. The stud alignment jig of claim 1 wherein the stud holding portions' inner dimensions are each fractionally greater than 1.5 inches so as to conform to common framing member width.

3. (canceled)

4. The stud alignment jig of claim 1 wherein the telescoping tubes of the central extension portion are disposed in such a manner so as to permit positive longitudinal arrest at distances where the spacing between the centers of the U-shapes stud-holding portions are either of 16″, 19.2″ and 24″.

5. (canceled)

6. The stud alignment jig of claims 1 or 2 wherein the plate tabs form an integral part of the central portion of the U-shaped stud holding jig wherein a further central portion thereof integrally extends slightly outwardly from the central upper portion of the U-shaped stud holding portion thus when in use, the plate tabs press against the top of a plate member to maintain even alignment between a stud and said plate member.

7. The stud alignment jig of claims 1, 2, 4 or 5 wherein the plurality of perforations through the outer tube are beveled so as to allow user to displace the nipple of the button latch even more downward to help release the locking position more easily.

8. The stud alignment jig of claims 1, 2, 3, 4, 5, 6 or 7 wherein the use thereof is to provide builders with a device that automatically spaces studs in the correct centers, aligns studs with plates and plumbs twisted studs during nailing.
